(19) United States
(12) Patent Application Publication
(10) Pub. No.: US 2002/0012085 A1
(43) Pub. Date: Jan. 31, 2002

(54) Scattering sheet, and laminated sheet and liquid crystal display device using the same

(76) Inventors: Masaru Honda, Niihama-shi (JP); Makoto Namioka, Niihama-shi (JP); Norihiro Miwa, Niihama-shi (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/809,259

(22) Filed: Mar. 16, 2001

(30) Foreign Application Priority Data
Mar. 21, 2000 (JP) 2000-078141
Dec. 25, 2000 (JP) 2000-392265

(51) Int. Cl. G02F 1/1335

(52) U.S. Cl. 349/112

(57) ABSTRACT

The present invention provides a scattering sheet obtained by forming a scattering resin into a sheet having a thickness of about 1 μm to about 100 μ/m, and having a total light transmittance of about 85% or more and less than about 100%, and a haze of about 50% or more and less than about 90%, wherein the scattering resin comprising a colorless transparent resin and colorless transparent spherical particles dispersed in the colorless transparent resin, a difference between a refractive index of the colorless transparent resin and a refractive index of the colorless transparent is more than about 0.00 and not more than about 0.05, an average particle size of the colorless transparent spherical particles is about 2 μm or more and not more than about 5 μm, and a content of the colorless transparent spherical particles is about 1 to about 100 parts by weight with respect to 100 parts by weight of the colorless transparent resin, and the scattering sheet of the present invention is preferably used for a forward scattering sheet of a liquid crystal display device.

### BACKGROUND OF THE INVENTION

1. Field of the Invention

The present invention relates to a scattering sheet, and a laminated sheet and a liquid crystal display device using the scattering sheet. The scattering sheet of the present invention is preferably used for a forward scattering sheet of a liquid crystal display device.

2. Description of the Related Art

In recent years, with widespread use of cellular phones and portable terminals, demands for reflective or transflective liquid crystal display devices that consume smaller power have increased. The transflective liquid crystal displays are widely used which can be used as a reflective liquid crystal display under light environment and can be used as a transmissive liquid crystal display by illumination from a built-in back light source under dark environment. This dual function of reflection and transmission leads to the designation, “transflective”. In addition, requests for color display devices have increased as the amount of information has become greater.

Conventionally, in monochrome reflective or transflective liquid crystal display devices, white display in the reflection mode has been realized by placing polarizing films on the front and back of a liquid crystal cell and further placing a reflective film or a transflective film on the back of the back polarizing film. However, in color reflective or transflective liquid crystal display devices, the mainstream method is placing a reflective layer inside a liquid crystal cell, not outside the liquid crystal cell, for improving the luminance at white display and preventing lowering of the chroma of a displayed color due to the parallax. To realize white display, external light must be scattered by a reflective layer. For this purpose, proposed are a method where fine concave and convex portions are provided for a reflective layer placed inside a liquid crystal cell, and a method where a reflective layer itself is a mirror reflector and a forward scattering sheet is additionally formed on the front of the mirror reflector. As such a forward scattering sheet, some methods have been proposed including that described in Japanese Laid-Open Patent Publication No. 9-113893, for example, where a light control plate is used. However, none of these have succeeded in achieving sufficient performance due to problems such as viewing angle dependency.

### SUMMARY OF THE INVENTION

An object of the present invention is to provide a scattering sheet capable of providing brightness and contrast higher than those conventionally obtained for a reflective or transflective liquid crystal display device having a mirror reflective layer inside a liquid crystal cell, and a laminated film and a liquid crystal display device using such a scattering sheet.

The present invention provides a scattering sheet obtained by forming a scattering resin into a sheet having a thickness of about 1 μm to about 100 μm, and having a total light transmittance T satisfying expression(I):

about 85% ≦T< about 100% (I)

and a haze Hz satisfying expression (II):

about 50%≦Hz< about 90% (II),

wherein the scattering resin comprising a colorless transparent resin and colorless transparent spherical particles dispersed in the colorless transparent resin, a refractive index n(R) of the colorless transparent resin and a refractive index n(F) of the colorless transparent spherical particle satisfy expression(III):

about 0.00<n(R)−n(F)≦ about 0.05 (III),

an average particle size f of the colorless transparent spherical particles satisfies expression(IV):

about 2 μm≦φ≦ about 5 μm (IV),

and a content of the colorless transparent spherical particles is about 1 to about 100 parts by weight with respect to 100 parts by weight of the colorless transparent resin.

The amount of the colorless transparent spherical particles contained in the scattering resin can be about 100 parts by weight at maximum with respect to 100 parts by weight of the colorless transparent resin, but advantageously it is up to about 50 parts by weight. The refractive index n(R) of the colorless transparent resin preferably satisfies expression (V):

about 1.40<n(R)≦ about 1.50 (V).

The colorless transparent resin is preferably an acrylic pressure-sensitive adhesive. This eliminates the necessity of separately preparing an adhesive including a pressure-sensitive adhesive when the member is used in combination with another sheet as a laminate, and thus advantageously simplifies the construction. The colorless transparent spherical particles are preferably made of a silicone resin. This makes it easy to select the colorless transparent resin that satisfies expression (III). The phase retardation value of the scattering sheet is preferably about 30 nm or less.

The present invention also provides a laminated sheet including the scattering sheet described above sandwiched by two resin sheets, and a laminated sheet including the scattering sheet described above and a stretched resin sheet.

The stretched resin sheet may be a polarizing film or a phase retardation film. The phase retardation film may be selected from a quarter-wave film and a half-wave film. Naturally, both a polarizing film and a phase retardation film may be formed on the scattering sheet in layers. In particular, when used for a liquid crystal display device, the laminated sheet may include a polarizing film, at least one phase retardation film, and the scattering sheet described above.

The laminated sheet may also include the scattering sheet described above and a reflective film or a transflective film. A polarizing film may be additionally formed, to provide a laminated sheet including at least three layers of the polarizing film, the scattering sheet described above, and a reflective film or a transflective film.

The present invention further provides a liquid crystal display device comprising a laminated sheet including a polarizing film, at least one phase retardation film, and the scattering sheet described above formed on the front of a liquid crystal cell. Another polarizing film, together with another phase retardation film as required, is formed on the back of the liquid crystal cell. A backlighting device may also be placed on the back of the polarizing film.

As another embodiment, provided is a liquid crystal display device comprising: a polarizing film, together with a phase retardation film as required, formed on the front of a liquid crystal cell; and a laminated sheet described above, including a polarizing film, the scattering sheet described above, and a reflective film or a transflective film formed on the back of the liquid crystal cell, together with a phase retardation film as required. A backlighting device may also be placed on the back of the laminated sheet as required.

### BRIEF DESCRIPTION OF DRAWINGS

FIG. 1 is a schematic cross-sectional view of an embodiment of the laminated sheet of the present invention.

FIG. 2 is a schematic cross-sectional view of another embodiment of the laminated sheet of the present invention.

FIG. 3 is a schematic cross-sectional view of yet another embodiment of the laminated sheet of the present invention.

FIG. 4 is a schematic cross-sectional view of yet another embodiment of the laminated sheet of the present invention.

FIG. 5 is a schematic cross-sectional view of yet another embodiment of the laminated sheet of the present invention.

FIG. 6 is a schematic illustration of the axial angles formed by the absorption axis of a polarizing film, the optical axis of a half-wave film and the optical axis of a quarter-wave film used for the laminated sheet.

FIG. 7 is a schematic cross-sectional view of yet another embodiment of the laminated sheet of the present invention.

FIG. 8 is a schematic cross-sectional view of an embodiment of the liquid crystal display device of the present invention.

FIG. 9 is a schematic cross-sectional view of another embodiment of the liquid crystal display device of the present invention.

FIG. 10 is a schematic cross-sectional view of yet another embodiment of the liquid crystal display device of the present invention.

FIG. 11 is a schematic cross-sectional view illustrating the construction of a reflection white luminance evaluation apparatus used for measurement of reflection luminance and reflection contrast (direct illumination) in examples of the present invention.

FIG. 12 is a schematic cross-sectional view illustrating the construction of a reflection black luminance evaluation apparatus used for measurement of reflection luminance and reflection contrast (direct illumination) in examples of the present invention.

### DESCRIPTION OF PREFERRED EMBODIMENTS

Hereinafter, the present invention will be described in detail. The scattering sheet of the present invention is obtained by forming a scattering resin into a sheet having a thickness of about 1 to about 100 μm. The scattering resin contains colorless transparent spherical particles dispersed in a colorless transparent resin. The colorless transparent resin and the colorless transparent spherical particles constituting the scattering sheet are selected so that the refractive index n(R) of the former and the refractive index n(F) of the latter satisfy expression (III) above. That is, the refractive index n(R) of the colorless transparent resin must be greater than the refractive index n(F) of the colorless transparent spherical particles, but the difference therebetween must not exceed about 0.05.

The material of the colorless transparent resin used in the invention is not specifically limited, and various known resins may be used as long as they are colorless and transparent. For example, usable are synthetic polymers including polyolefin resins such as polyethylene and polypropylene, polystyrene resins, polyvinyl chloride resins, polyvinyl acetate resins, polyester resins such as polyethylene terephthalate and polyethylene naphthalate, cyclic polyolefin resins such as norbornene polymers, polycarbonate resins, polysulfone resins, polyethersulfone resins, polyallylate resins, polyvinyl alcohol resins, polyurethane resins, polyacrylate resins, and polymethacrylate resins, and natural polymers including cellulose resins such as cellulose diacetate and cellulose triacetate. Synthetic polymers may be homopolymers having one kind of monomer, or may be copolymers composed of two or more kinds of monomers constituting any of the above resins.

The colorless transparent resin may be a pressure-sensitive adhesive. Examples of the pressure-sensitive adhesive usable include acrylic pressure-sensitive adhesives, vinyl chloride pressure-sensitive adhesives, synthetic rubber pressure-sensitive adhesives, natural rubber pressure-sensitive adhesives, and silicone adhesives. Among these pressure-sensitive adhesives, acrylic pressure-sensitive adhesives are preferable for their easiness in handling and durability. An acrylic pressure-sensitive adhesive is made of a copolymer mainly composed of: a major monomer component having a low glass transition temperature that provides tackiness; a co-monomer component having a high glass transition temperature that provides adhesion and aggregation; and a monomer component containing functional group for improvement of cross-linking and adhesion. Examples of the major monomer component include: acrylic alkyl esters such as ethyl acrylate, butyl acrylate, amyl acrylate, 2-ethylhexyl acrylate, octyl acrylate, cyclohexyl acrylate, and benzyl acrylate; and methacrylic alkyl esters such as butyl methacrylate, amyl methacrylate, 2-ethylhexyl methacrylate, octyl methacrylate, cyclohexyl methacrylate, and benzyl methacrylate. Examples of the co-monomer component include methyl acrylate, methyl methacrylate, ethyl methacrylate, vinyl acetate, styrene, and acrylonitrile. Examples of the monomer component containing functional group includes: monomers containing carboxyl group such as acrylic acid, methacrylic acid, maleic acid, and itaconic acid; monomers containing hydroxyl group such as 2-hydroxyethyl (meth)acrylate, 2-hydroxypropyl (meth)acrylate, and N-methylolacrylamide; and acrylamide, methacrylamide, and glycidyl methacrylate.

The pressure-sensitive adhesive is preferably of a cross-linking type. Cross-linking can be obtained by methods including addition of any of various cross-linking agents such as epoxy compounds, isocyanate compounds, metal chelate compounds, metal alkoxides, metal salts, amine compounds, hydrazine compounds, and aldehyde compounds, and irradiation with radioactive rays. An appropriate method is selected depending on the kind of the functional group. The weight-average molecular weight of the major polymer constituting the pressure-sensitive adhesive is preferably in the order of about 600,000 to about 2,000,000, more preferably in the order of about 800,000 to about 1,800,000. If the weight-average molecular weight is less than about 600,000, the cohesion to an adherend and durability of the adhesive deteriorate. If the weight-average molecular weight exceeds about 2,000,000, the elasticity of the adhesive increases, deteriorating the flexibility, especially in the case that the amount of a plasticizer is small. As a result, the adhesive fails to absorb and alleviate contraction stress that may be generated from the adherend.

The pressure-sensitive adhesive is preferably blended with a plasticizer. Examples of the plasticizer include esters such as phthalic acid esters, trimellic acid esters, pyromellic acid esters, adipic acid esters, sebacic acid esters, phosphoric acid triesters, and glycol esters, process oils, liquid polyethers, liquid polyterpenes, and other liquid resins. One kind among these plasticizers may be used alone, or two or more kinds may be used in combination. In addition, various additives such as an UV absorber, a light stabilizer, and an antioxidant may be added to the pressure-sensitive adhesive as required.

The colorless transparent resin may be a photo-curing resin or a thermosetting resin. Known photo-curing or thermosetting resins may be used. Examples include resins composed of compounds having a reactive double bond such as an acrylate group, a methacrylate group, and an aryl group, and compounds having a ring-opening condensation reactive group such as an epoxy group. For curing with light or heat, an additive such as a photo-polymerization initiator, a thermal stabilizer, an UV stabilizer, and a leveling agent may be added to the resin. The curing with light or heat can be performed by a known method.

In consideration of the application of the scattering sheet of the invention to a liquid crystal display device, which is a major use of the scattering sheet, it is preferable to have small reflection at the interface of the scattering sheet with another member. Therefore, the refractive index n(R) of the colorless transparent resin is preferably in the range of about 1.40<n(R)≦ about 1.50.

The material of the colorless transparent spherical particles used for the invention is not specifically limited, and known organic particles and inorganic particles can be used. Examples of the organic particles include particles of: polyolefin resins such as polystyrene, polyethylene, and polypropylene; and (meth)acrylate polymers such as polymethacrylate resins and polyacrylate resins. The organic particles may be cross-linked polymers. It is also possible to use a copolymer of two or more kinds of monomers selected from ethylene, propylene, styrene, methyl methacrylate, benzoguanamine, formaldehyde, melamine, butadiene, and the like. Examples of the inorganic particles include particles of silica, silicone, titanium oxide, aluminum oxide, and the like. Considering that the colorless transparent resin and the colorless transparent spherical particles must satisfy expression(III) and that an acrylic pressure-sensitive adhesive is preferably used as the material of the colorless transparent resin, silicone particles (refractive index: about 1.44) is preferable as the material of the colorless transparent spherical particles.

In order to improve the cohesion of the colorless transparent resin with the colorless transparent spherical particles, the surfaces of the particles may be subjected to coupling processing. Although particles in the shape of a perfect sphere are most preferable, other particles can also be used without causing any trouble as long as they are roughly spherical. If the average particle size is too small, the degree of polarization of incident polarized light decreases, that is, the polarization canceling function works. Therefore, the average particle size must be about 2 μm or more. If the average particle size is too large, the image quality deteriorates when the resultant film is used for a liquid crystal display device. Therefore, the average particle size must be about 5 μm or less. For the above reasons, also, the particle size distribution is preferably narrow. A wide particle size distribution has a possibility of including particles having average particle sizes of less than about 2 μm or more than about 5 μm. This will result in reduction in the degree of polarization and deterioration in image quality. The content of the particles added is about 1 to bout 100 parts by weight with respect to 100 parts by weight of the colorless transparent resin in which the particles are dispersed. If the amount is less than the above range, a desired forward scattering ability is not obtained. If the amount exceeds the above range, properties such as the mechanical properties of the product are adversely influenced. Preferably, about 1 to about 50 parts by weight of the colorless transparent spherical particles is used for 100 parts by weight of the colorless transparent resin.

The method for obtaining the scattering sheet from the scattering resin is not specifically limited, and a known method can be employed. Examples of such a method include: a method where the scattering resin is formed into a sheet by extrusion with a T die or the like; a method where the scattering resin in a molten state is applied to a substrate and then cooled; and a method where the scattering resin, mixed in a solvent, is applied to a substrate and then dried. In the case where the scattering resin is a photo-curing or thermosetting resin, the scattering sheet can also be obtained by painting a material composition on a substrate so as to have a shape of a sheet, then, curing the sheet-shaped material composition by a known method.

In the use of the scattering sheet for a liquid crystal display device, if the scattering sheet is too thin, handling of the sheet is difficult. If it is too thick, the thickness of the resultant liquid crystal display device increases. Therefore, the thickness of the scattering sheet should be about 1 to about 100 μm, more preferably about 10 to about 50 μm.

The total light transmittance T of the scattering sheet is about 85% or more and less than bout 100%, preferably about 90% or more and less than 100%. A higher total light transmittance is more preferable within this range. The haze Hz is set at a value within the range of about 50% to about 90% depending on desired performance. If the scattering sheets are same in the thickness, the total light transmittance decreases and the haze increases, as the content of the colorless transparent spherical particles increases. Therefore, the total light transmittance and the haze of the scattering sheet can be controlled by a method where the thickness of the scattering sheet is thinned in the case of increasing the content of the colorless transparent spherical particles in the colorless transparent resin, or the thickness of the scattering sheet is thickened in the case of decreasing the content of the colorless transparent spherical particles in the colorless transparent resin. Further, the total light transmittance decreases and the haze increases as the difference between the refractive indexes of the colorless transparent resin and the colorless transparent spherical particles becomes larger. The total light transmittance and the haze of the scattering sheet can be controlled by a method where the thickness of the scattering sheet is thinned in the case of large difference between the refractive indexes, or the thickness of the scattering sheet is thickened in the case of small difference between the refractive indexes.

The total light transmittance and the haze of the scattering sheet is controlled in the range mentioned above by changing the thickness, the difference between the refractive index of the colorless transparent resin and the refractive index of the colorless transparent spherical particles, the average particle size of the colorless transparent spherical particles, or the content of the colorless transparent spherical particles added in the colorless transparent resin in the range mentioned above.

In the use of the scattering sheet for a liquid crystal display device, it is preferable that an in-plane phase retardation of the scattering sheet is smaller. Specifically, the in-plane phase retardation is preferably about 30 nm or less, more preferably about 10 nm or less, most preferably about 0 nm.

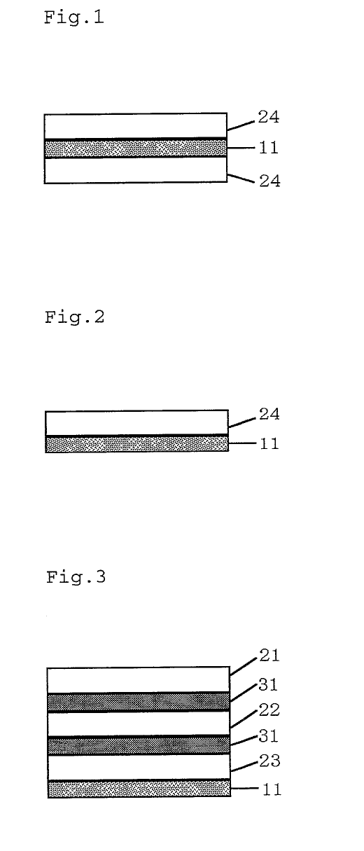

The scattering sheet can be stored or used in the form of a laminated sheet as schematically shown in FIG. 1 in cross section, where a scattering sheet 11 is sandwiched by two resin sheets 24, 24, for easiness of handling. Alternatively, when used for a liquid crystal display device, the scattering sheet can be in the form of a laminated sheet as schematically shown in FIG. 2 in cross section, where a stretched resin sheet 24 and a scattering sheet 11 are formed in layers. A material of the resin sheet 24 is not specifically limited, and a known resin can be used. For example, usable are synthetic polymers including polyolefin resins such as polyethylene and polypropylene, polyvinyl chloride resins, polyvinyl acetate resins, polyester resins such as polyethylene terephthalate and polyethylene naphthalate, cyclic polyolefin resins such as norbornene polymers, polycarbonate resins, polysulfone resins, polyethersulfone resins, polyallylate resins, polyvinyl alcohol resins, polyurethane resins, polyacrylate resins, and polymethacrylate resins, and natural polymers including cellulose resins such as cellulose diacetate and cellulose triacetate. The resin sheet 24 may also be a pressure-sensitive adhesive. Examples of the pressure-sensitive adhesive usable include acrylic pressure-sensitive adhesives, vinyl chloride pressure-sensitive adhesives, synthetic rubber pressure-sensitive adhesives, natural rubber pressure-sensitive adhesives, and silicone adhesives.

The stretched resin sheet may be a polarizing film or a phase retardation film. A known polarizing film may be used. Often used is a polarizing film made by dying a polyvinyl alcohol resin film with iodine or a dichroic dye. Since the polyvinyl alcohol resin is poor in water resistance, it is preferably coated with a protection film. A cellulose triacetate resin film is normally used as the protection film. As a phase retardation film, also, a known one may be used. For example, films made of polycarbonate resins, polysulfone resins, polyethersulfone resins, polyallylate resins, norbornene resins and the like may be mainly used. Stretching of films can be done by a known method. Often used are longitudinal stretching such as inter-roll stretching and transverse stretching such as tenter stretching. Uniaxial stretching may be adopted. However, for viewing angle adjustment in the case of use for a liquid crystal display device, orientation in the thickness direction may be performed as required. The phase retardation value of the phase retardation film may be appropriately determined depending on desired characteristics. In the case of use for a reflective or transflective liquid crystal display device, the phase retardation film normally has a phase retardation value of bout 100 to about 1,000 nm. In a preferred embodiment, a quarter-wave film or a half-wave film is used.

When the scattering sheet of the invention is used as a forward scattering sheet for a reflective or transflective liquid crystal display device, in particular, it is preferably in the form of a laminated sheet including a polarizing film, at least one phase retardation film, and the scattering sheet. For example, in the case of use for a thin film transistor (TFT) driven reflective liquid crystal display device, laminated sheets as schematically shown in FIGS. 3, 4, and 5 in cross section are preferably used. In these laminated sheets, a polarizing film 21, a half-wave film 22,and a quarter-wave film 23 are formed in layers in this order to constitute a so-called wide-band circular polarizing film where the optical axis 82 of the half-wave film and the optical axis 83 of the quarter-wave axis cross each other at an angle of roughly 60°, and the absorption axis 81 of the polarizing film and the optical axis 82 of the half-wave axis cross each other at an angle of roughly 15° as schematically shown in FIG. 6. Such a wide-band circular polarizing film is formed on a scattering sheet 11.

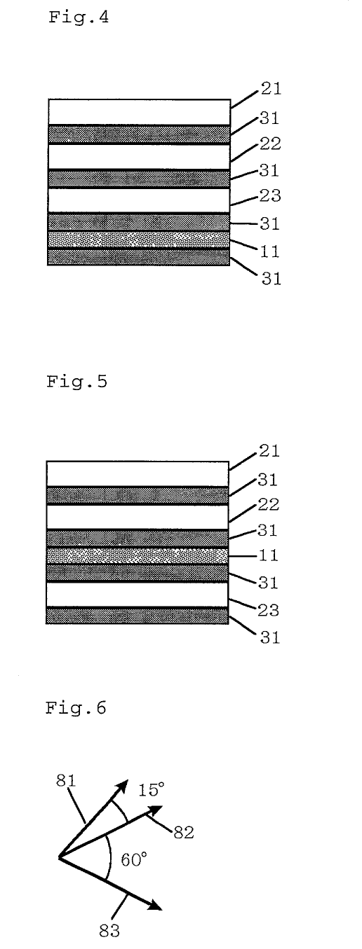

In FIG. 3, the polarizing film 21, the half-wave film 22, and the quarter-wave film 23 are formed in layers with pressure-sensitive adhesives 31 therebetween. The resultant structure is formed on the scattering sheet 11 with the side of the quarter-wave film 23 facing the scattering sheet 11. The structure in FIG. 4 is roughly the same as that in FIG. 3. In this structure, however, layers of pressure-sensitive adhesives 31 are formed on both surfaces of the scattering sheet 11, and one of the layers adheres to the quarter-wave film 23. In FIG. 5, layers of pressure-sensitive adhesives 31 are formed on both surfaces of the scattering sheet 11. On one of the layers, formed are the half-wave film 22 and the polarizing film 21 with a pressure-sensitive adhesive 31 therebetween. The quarter-wave film 23 is formed on the other layer, and a pressure-sensitive adhesive 31 is formed on the other surface of the quarter-wave film 23.

When the scattering sheet of the invention is used as a transflective plate for a reflective or transflective liquid crystal display device, in particular, it is preferably used in the form of a laminated sheet including the scattering sheet and a reflective film or a transflective film. Also preferred is a laminated sheet including a polarizing film, the scattering sheet, and a reflective or transflective film. The reflective film as used herein refers to a film that reflects incident light rays. The transflective film as used herein refers to a film that transmits part of incident rays and reflects part of the remaining incident rays. The remainder of the total incident light rays that is neither transmitted nor reflected is absorbed by the transflective film, which is not effectively used. Therefore, the absorption is preferably as small as possible.

An example of a laminated sheet including a polarizing film, a scattering sheet, and a reflective film or a transflective film is schematically shown in FIG. 7 in cross section. In FIG. 7, a substrate 26 with a thin metal film 25 formed thereon constitutes a reflective film or a transflective film. On this structure, a pressure-sensitive adhesive 31, a polarizing film 21, and a scattering sheet 11 are formed in this order. In place of the substrate 26 with the thin metal film 25 formed thereon shown in FIG. 7, other structures such as a multi-layer structure of two or more kinds of thin polymer films may be used as the reflective film or the transflective film. Each of the layers may be a single layer or a laminate of two or more layers. In the case of a laminate of two or more layers, the layers may be the same, or different from each other.

The material of the substrate used for the reflective film or the transflective film is not specifically limited. For example, usable are synthetic polymers including polyolefin resins such as polyethylene and polypropylene, polyvinyl chloride resins, polyvinyl acetate resins, polyester resins such as polyethylene terephthalate and polyethylene naphthalate, cyclic polyolefin resins such as norbornene polymers, polycarbonate resins, polysulfone resins, polyethersulfone resins, polyallylate resins, polyvinyl alcohol resins, polyurethane resins, polyacrylate resins, and polymethacrylate resins, and natural polymers including cellulose resins such as cellulose diacetate and cellulose triacetate. Also, thin metal films made of aluminum, silver, stainless steel, and the like may be directly used as the reflective film or the transflective film.

The metal used as the thin metal film for the reflective film or the transflective film is not specifically limited, and aluminum, silver, and the like are preferably used. The thickness of the thin metal film is determined depending on desired transmission performance and reflection performance. In other words, if importance is put on increasing the transmittance of the transflective film and thus decreasing the reflectance thereof, the thin metal film is made thin. In this way, the transmittance can be kept high while the reflectance can be lowered. On the contrary, if importance is put on increasing the reflectance and thus decreasing the transmittance, the thin metal film is made thick. In this way, the transmittance can be lowered while the reflectance can be increased. In view of the above, the thickness of the thin metal film is normally about 1 nm to about 100 μm, more preferably about 10 nm to about 1 μm. Evaporation or sputtering is preferably employed for forming such a thin metal film on a transparent polymer film. Alternatively, a thinly rolled metal film may be bonded to a transparent polymer film with an adhesive including a pressure-sensitive adhesive. In the formation of the thin metal film on a resin, a known undercoat layer may be formed for improvement of cohesion, or a known undercoat layer may be formed for protection of the thin metal film.

In the case where a multi-layer structure of thin polymer films is used as the transflective film, the material of the thin polymer film is not specifically limited, and those exemplified above as resins usable for the substrate can also be used. The method described in “Polymer Engineering and Science”, No. 13 (1973), p.216 by J. A. Radford, for example, can be adopted to form a multi-layer structure of thin polymer films provided with reflection performance.

In the production of the laminated sheet of the invention, the films are preferably put in close contact each other using a pressure-sensitive adhesive for minimizing loss of light due to reflection generated at interfaces between the films. A known pressure-sensitive adhesive can be used. Examples of the pressure-sensitive adhesive usable include acrylate pressure-sensitive adhesives, methacrylate pressure-sensitive adhesives, vinyl chloride pressure-sensitive adhesives, synthetic rubber pressure-sensitive adhesives, natural rubber pressure-sensitive adhesives, and silicone adhesives. Among these pressure-sensitive adhesives, acrylate pressure-sensitive adhesives are especially preferable for their easiness in handling and durability.

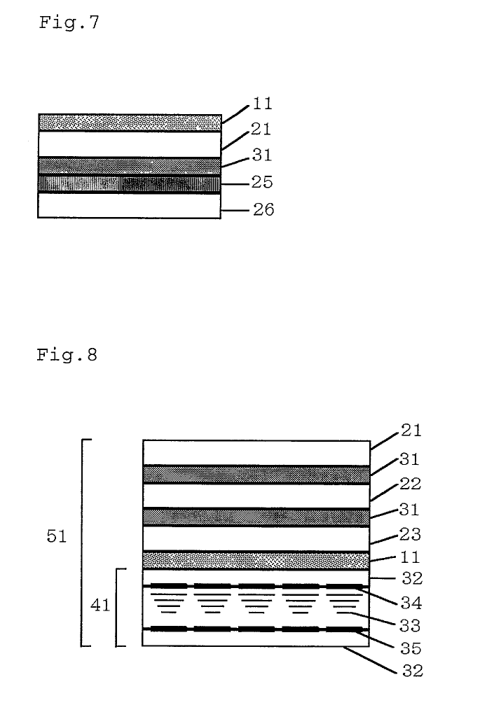

FIG. 8 is a schematic cross-sectional view of an embodiment of a liquid crystal display device using the laminated sheet of the invention. In this embodiment, a laminated sheet including a polarizing film 21, phase retardation films 22, 23, and a scattering sheet 11 is placed on the front of a liquid crystal cell 41, thereby constituting a liquid crystal display device 51. The laminated sheet used in this embodiment is the same as that shown in FIG. 3. That is, the polarizing film 21, the half-wave film 22, and the quarter-wave film 23 are formed in layers with pressure-sensitive adhesives 31 therebetween, and the resultant structure is formed on the scattering sheet 11 with the quarter-wave film 23 facing the scattering sheet 11. The liquid crystal cell 41 includes liquid crystal material 33 injected therein. By changing the orientation state of the liquid crystal material with application of a voltage, polarized light passing the inside of the cell is sequentially changed from linearly polarized light to circularly polarized light, or from circularly polarized light to linearly polarized light. As the liquid crystal cell, usable are known twisted nematic (TN), super twisted nematic (STN), and optically compensated bend (OCB) liquid crystal cells. In FIG. 8, the cell is constructed of two opposing glass plates 32, 32 and sidewalls. The cell also includes a transparent electrode 34 formed on the front glass plate, a reflection electrode 35 formed on the back glass plate, and the liquid crystal material 33 injected in the cell.

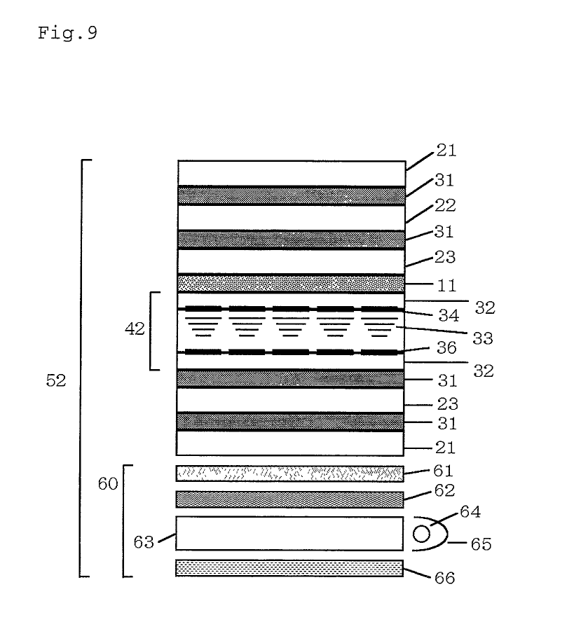

FIG. 9 is a schematic cross-sectional view of another embodiment of a liquid crystal display device using the laminated sheet of the invention. In this embodiment, a laminated sheet including a polarizing film 21, phase retardation films 22, 23, and a scattering sheet 11 is placed on the front of a liquid crystal cell 42. On the back of the liquid crystal cell 42, formed are another polarizing film 21 and another phase retardation film 23. Further, a backlighting device 60 is placed on the back polarizing film 21. The phase retardation film 23 on the back of the liquid crystal cell 42 may be formed as required.

The structure of the laminated sheet formed on the front of the liquid crystal cell 42 is the same as that shown in FIG. 8. In this embodiment, also, a known liquid crystal cell such as TN, STN, and OCB liquid crystal cells can be used. The liquid crystal cell 42 is constructed of two opposing glass plates 32, 32 and sidewalls. The cell further includes a transparent electrode 34 formed on the front glass plate, a transflective electrode 36 formed on the back glass plate, and liquid crystal material 33 injected in the cell. The transflective electrode 36 may be made of transflective metal or a multi-layer thin film electrode. Otherwise, usable is an electrode obtained by forming fine pores through a reflective metal film to allow part of light rays to pass therethrough.

On the back of the liquid crystal cell 42, the back phase retardation film 23 is formed with a pressure-sensitive adhesive 31 therebetween. The back polarizing film 21 is then formed on the back phase retardation film 23 with a pressure-sensitive adhesive 31 therebetween. The backlighting device 60 placed on the back of the back polarizing film 21 includes a lens sheet 61, a diffusion sheet 62, a light transmitting plate 63, a light source 64 for emitting light to the light transmitting plate 63, a reflector 65 for collecting light from the light source 64 into the light transmitting plate 63, and a reflective sheet 66 for reflecting most of light transmitted by the light transmitting plate 63.

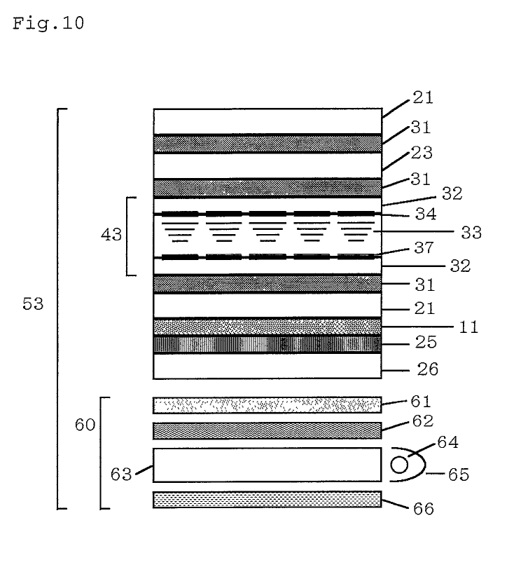

FIG. 10 is a yet another embodiment of a liquid crystal display device using the laminated sheet of the invention. In this embodiment, a polarizing film 21 and a phase retardation film 23 are formed on the front of a liquid crystal cell 43. On the back of the liquid crystal cell 43, formed is a laminated sheet including another polarizing film 21, a scattering sheet 11, and a reflective or transflective film that is composed of a substrate 26 and a thin metal film 25 formed thereon. A backlighting device 60 is placed on the back of the laminated sheet as required, to construct a liquid crystal display device 53. In this type of the device, the phase retardation film 23 on the front of the liquid crystal cell 43 may be formed as required, and a phase retardation film may be formed on the back of the liquid crystal cell 43 together with the polarizing film 21. The liquid crystal cell 43 in this embodiment is constructed of two opposing glass plates 32, 32 and sidewalls. The cell also includes a transparent electrode 34 formed on the front glass plate, a transparent electrode 37 formed on the back glass plate, and liquid crystal material 33 injected in the cell. In the liquid crystal cell 43, polarized light passing the inside of the cell is rotated, or the polarization state of light passing the inside of the cell by use of birefringence is changed, by changing the orientation state of the liquid crystal material with application of a voltage. A liquid crystal cell used for a normal transmissive liquid crystal display device can be used without change. The backlighting device 60 is the same as that shown in FIG. 9, and a backlighting device used for a normal transmissive or transflective liquid crystal display device can be used without change.

### EXAMPLES

Hereinafter, examples of the present invention will be described. It is to be understood that the invention is not intended to be limited to the following examples.

In the following examples, percentages (%) and parts representing the contents or amounts used of respective components are based on weight unless otherwise specified.

Tests used for evaluations of scattering sheets produced in the following examples are as follows.

(A) Total Light Transmittance and Haze

A scattering sheet itself, or a scattering sheet bonded to a glass plate with a pressure-sensitive adhesive as required, is placed on a haze computer HGM-2DP (manufactured by Suga Test Instruments) so that measurement light is incident on the side of the scattering sheet, for measurement of the total light transmittance and the haze.

(B) Reflection Luminance and Reflection Contrast (Direct Illumination)

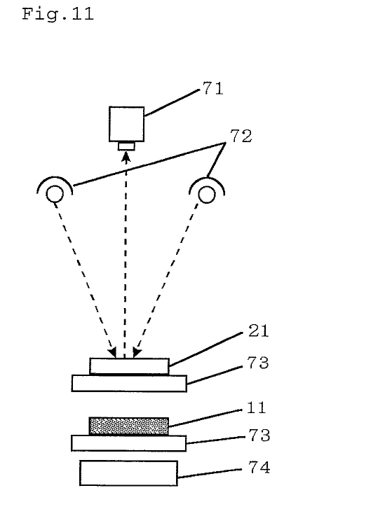

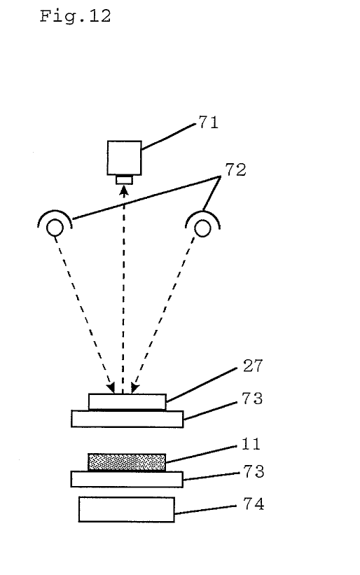

FIG. 11 and 12 show schematic cross-sectional views of a reflection white display luminance evaluation apparatus and a reflection black display luminance evaluation apparatus used in this test. A loupe was removed from a round loupe ENVB-2 (manufactured by Otsuka Kogaku Co., Ltd.), and the remainder was used as a ring external light source. An optical mirror 74 was placed at a position right below the center part of a ring fluorescent lamp 72 of the round loupe. On the optical mirror 74, placed was a scattering sheet 11 prepared in each of the examples together with a glass plate 73 to which the scattering sheet 11 is bonded with an pressure-sensitive adhesive as required so that the glass plate 73 faces the optical mirror 74. A luminance meter 71 is placed above the midpoint of the ring fluorescent lamp 72 so that the luminance of the scattering sheet 11 can be measured in the direction normal to the scattering sheet 11. A polarizing film 21 was placed above the scattering sheet 11 to simulate white display of a reflective liquid crystal display device, and in this state, the luminance was measured. On the contrary, a wide-band circular polarizing film 27 was placed above the scattering sheet 11 to simulate black display of a reflective liquid crystal display device, and in this state, the luminance was measured. The contrast was determined as the ratio of the white luminance to the black luminance measured at the same illumination angle. The illumination angle was adjusted by changing the distance between the ring fluorescent lamp 72 and the optical mirror 74, and an illuminometer was placed at the position of the optical mirror 74 to measure the illuminance.

(C) Reflection Luminance and Reflection Contrast (Direct Illumination+Indirect Illumination)

The illumination apparatus prepared in the test (B) above was sheathed with a cylinder of which the inner wall was covered with white paper, and the same measurement as that described in the test (B) was performed. Evaluation was thus performed in the state of combination of direct illumination from the ring fluorescent lamp 72 and indirect illumination by reflection from the white paper of the inner wall of the cylinder.

In the tests (B) and (C) above, as the polarizing film 21, used was a commercially available polyvinyl alcohol-iodine type polarizing film: SUMIKALAN® SR1862A (manufactured by Sumitomo Chemical Co., Ltd.). As the wide-band circular polarizing film 27, used was a laminated sheet including the polarizing film: SUMIKALAN® SR1862A, a commercially available half-wave film: SUMIKALIGHT® SEF460275 (manufactured by Sumitomo Chemical Co., Ltd.), and a commercially available quarter-wave film: SUMIKALIGHT® SEF340138 (manufactured by Sumitomo Chemical Co., Ltd.) formed in this order at the axial angles shown in FIG. 6.

Materials used for the manufacture of the scattering sheets are as follows.

As the colorless transparent resin, used were commercially available emulsions: NIKAZOL® FL-3000A (an acrylic copolymer having a solid content of 46% and a refractive index of its dry film: 1.48, manufactured by Nippon Carbide Industries Co., Ltd.), SUMIKAFLEX® S-900 (a vinyl acetate-ethylene-acrylic copolymer having a solid content of 49 to 51% and a refractive index of its dry film: 1.47, manufactured by Sumitomo Chemical Co., Ltd.), and POLYZOL® PSA SE-1400 (a styrene acrylic copolymer having a solid content of 50% and a refractive index of its dry film: 1.51, manufactured by Showa Highpolymer Co., Ltd.).

As the pressure-sensitive adhesive used as the colorless transparent resin, used were pressure-sensitive adhesives No. 0 (refractive index: 1.47) which is attached to a one-side adhesive-attached polarizing film (SUMIKALAN® SR1862AP0 where the end “0” indicates the grade of the pressure-sensitive adhesive, for example), pressure-sensitive adhesives No. 7 (refractive index: 1.47) which is attached to a one-side adhesive-attached phase retardation film (SUMIKALIGHT® SEF340138B7 where the end “7” indicates the grade of the pressure-sensitive adhesive, for example), both available from Sumitomo Chemical Co., Ltd., pressure-sensitive adhesives No. K(refractive index: 1.47), and pressure-sensitive adhesives No. T(refractive index: 1.48).

As the colorless transparent spherical particles, used were commercially available silicone resin particles: TOSPEARL® (refractive index: 1.44, manufactured by Toshiba Silicone Co., Ltd.), in three grades of #120 (average particle size: 2.0 μm), #130 (average particle size: 3.0 μm), and #145 (average particle size: 4.5 μm). Also used was a commercially available particles composed of benzoguanamine-formaldehyde condensate: EPOSTAR® MS (refractive index: 1.57, average particle size: 2.0 μm, manufactured by Nippon Shokubai Co., Ltd.).

### EXAMPLE 1

98 parts of NIKAZOL® FL-3000A as a water emulsion of the colorless transparent resin, and 2 parts of TOSPEARL #145 as the colorless transparent spherical particles were mixed. After dispersion, the mixture was applied to a glass plate and then air-dried, to obtain a scattering sheet. Since the solid content of the emulsion is 46%, the amount of the colorless transparent spherical particles is about 4 parts with respect to 100 parts of the colorless transparent resin. The resultant scattering sheet was subjected to test (C) above for evaluation of the reflection luminance and the reflection contrast (direct illumination+indirect illumination) at an illumination angle of 10°. The illuminance at this test was 2,570 lux. The physical property values and the results obtained are shown in Table 1. The reflection white luminance was more than 600cd/m², indicating that a bright screen can be provided.

### EXAMPLE 2

A scattering sheet was obtained in the same manner as that described in Example 1, except that 95 parts of NIKAZOL® FL-3000A, and 5 parts of TOSPEARLO #145, were used in this example. The amount of the colorless transparent spherical particles is about 11 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was more than 600 cd/m², indicating that a bright screen can be provided.

### EXAMPLE 3

A scattering sheet was obtained in the same manner as that described in Example 1, except that 93 parts of NIKAZOL® FL-3000A, and 7 parts of TOSPEARL® #145, were used in this example. The amount of the colorless transparent spherical particles is about 16 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was more than 600 cd/m², indicating that a bright screen can be provided.

### EXAMPLE 4

A scattering sheet was obtained in the same manner as that described in Example 1, except that the thickness of a layer of the mixture applied to the glass plate was different. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was more than 600 cd/m², indicating that a bright screen can be provided.

### Comparative Example 1

A scattering sheet was obtained in the same manner as that described in Example 4, except that 93 parts of NIKAZOL® FL-3000A, and 7 parts of TOSPEARL® #145, were used in this example. The amount of the colorless transparent spherical particles is about 16 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The physical property values and-the results obtained are shown in Table 1. The reflection white luminance was less than 600 cd/m², indicating that a dark screen is obtained.

### Comparative Example 2

A scattering sheet was obtained in the same manner as that described in Example 1, except that the thickness of a layer of the mixture applied to the glass plate was different. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was less than 600 cd/m², indicating that a dark screen is obtained.

### EXAMPLE 5

A scattering sheet was obtained in the same manner as that described in Comparative Example 2, except that 93 parts of NIKAZOL® FL-3000A and 7 parts of TOSPEARL® #145, was used in this example. The amount of the colorless transparent spherical particles is about 16 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was more than 600 cd/m², indicating that a bright screen can be provided.

### EXAMPLE 6

A scattering sheet was obtained in the same manner as that described in Example 1, except that SUMIKAFLEX® S-900 was used as the colorless transparent resin in this example. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was more than 600 cd/m² indicating that a bright screen can be provided.

### Comparative Example 3

A scattering sheet was obtained in the same manner as that described in Example 1, except that POLYZOL® PSA SE-1400 was used as the colorless transparent resin in this example. The resultant scattering sheet was subjected to test (C) for evaluation of the reflection luminance and the reflection contrast (direct illumination+indirect illumination) at an illumination angle of 10°. The physical property values and the results obtained are shown in Table 1. The reflection white luminance was less than 600 cd/m², indicating that a dark screen is obtained.

TABLE 1

| | | Total | | | |
|---|---|---|---|---|---|
| | | light | | Reflection | |
| | Film | trans- | | white | |
| | thickness | mittance | Haze | luminance | |
| | (μm) | (%) | (%) | (cd/m²) | Contrast |
| Example 1 | 38 | 92.2 | 58.4 | 739 | 59 |
| Example 2 | 41 | 93.2 | 78.4 | 745 | 50 |
| Example 3 | 35 | 95.4 | 86.2 | 644 | 37 |
| Example 4 | 88 | 93.7 | 78.9 | 727 | 49 |
| Comparative | 80 | 94.6 | 91.3 | 446 | 17 |
| example 1 | | | | | |
| Comparative | 9 | 92.3 | 20.5 | 323 | 40 |
| example 2 | | | | | |
| Example 5 | 8 | 93.0 | 66.2 | 790 | 56 |
| Example 6 | 37 | 93.5 | 74.4 | 751 | 48 |
| Comparative | 37 | 94.1 | 81.2 | 587 | 31 |
| example 3 | | | | | |

### EXAMPLE 7

93 parts of SUMIKAFLEX® S-900 as a water emulsion of the colorless transparent resin and 7 parts of TOSPEARL® #145 as the colorless transparent spherical particles were mixed. After dispersion, the mixture was applied to a glass plate and then air-dried, to obtain a scattering sheet. Since the solid content of the emulsion is about 50%, the amount of the colorless transparent spherical particles is about 15 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The illuminance at this test was 2,550 lux. The physical property values and the results obtained are shown in Table 2. The reflection white luminance was more than 600 cd/m², indicating that a bright screen can be provided.

### EXAMPLE 8

A scattering sheet was obtained in the same manner as that described in Example 7, except that TOSPEARL® #130 was used as the colorless transparent particles and that 93 parts of SUMIKAFLEX® S-900, and 7 parts of TOSPEARL® #130 were used in this example. The amount of the colorless transparent spherical particles is about 15 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The physical property values and the results obtained are shown in Table 2. The reflection white luminance was more than 600 cd/m², indicating that a bright screen can be provided.

### EXAMPLE 9

A scattering sheet was obtained in the same manner as that described in Example 7, except that TOSPEARL® #120 was used as the colorless transparent particles and that 93 parts of SUMIKAFLEX® S-900, and 7 parts of TOSPEARL® #120 were used in this example. The amount of the colorless transparent spherical particles is about 15 parts with respect to 100 parts of the colorless transparent resin. The resultant scattering sheet was subjected to test (C) for evaluation of the reflection luminance and the reflection contrast (direct illumination+indirect illumination) at an illumination angle of 10°. The physical property values and the results obtained are shown in Table 2. The reflection white luminance was more than 600 cd/m², indicating that a bright screen can be provided.

TABLE 2

| | | Total | | | |
|---|---|---|---|---|---|
| | | light | | Reflection | |
| | Film | trans- | | white | |
| | thickness | mittance | Haze | luminance | |
| | (μm) | (%) | (%) | (cd/m²) | Contrast |
| Example 7 | 29 | 93.4 | 74.4 | 758 | 50 |
| Example 8 | 47 | 94.1 | 76.3 | 654 | 36 |
| Example 9 | 40 | 94.0 | 76.7 | 604 | 32 |

### EXAMPLE 10

87 parts in terms of the solid content of a material solution of the pressure-sensitive adhesive No. 0 as the colorless transparent resin and 13 parts of TOSPEARL® #145 as the colorless transparent spherical particles were mixed. After dispersion, the mixture was applied to a biaxially stretched and release-processed polyethylene terephthalate film having a thickness of 38 μm, air-dried, and then thermally cured, to obtain a scattering sheet. The amount of the colorless transparent spherical particles is about 15 parts with respect to 100 parts of the colorless transparent resin. After the surface of the scattering sheet composed of the pressure-sensitive adhesive of the resultant sheet was laminated on a glass plate, the polyethylene terephthalate film was peeled off, and the scattering sheet laminated on a glass plate was obtained. This scattering sheet was subjected to test (B) above for evaluation of the reflection luminance and the reflection contrast (direct illumination) at an illumination angle of 15°. The illuminance at this test was 2,030 lux. The physical property values and the results obtained are shown in Table 3. The reflection white luminance was more than 600 cd/m² indicating that a bright screen can be provided.

EXAMPLE 11

A scattering sheet was obtained in the same manner as that described in Example 10, except that the pressure-sensitive adhesive No. K was used as the colorless transparent resin in this example. The scattering sheet laminated on a glass plate was obtained in the same manner as that described in Example 10. This scattering sheet was subjected to test (B) for evaluation of the reflection luminance and the reflection contrast (direct illumination) at an illumination angle of 15°. The physical property values and the results obtained are shown in Table 3. The reflection white luminance was more than 600 cd/m², indicating that a bright screen can be provided.

### EXAMPLE 12

A scattering sheet was obtained in the same manner as that described in Example 10, except that the pressure-sensitive adhesive No. 7 was used as the colorless transparent resin in this example. The scattering sheet laminated on a glass plate was obtained in the same manner as that described in Example 10. This scattering sheet was subjected to test (B) for evaluation of the reflection luminance and the reflection contrast (direct illumination) at an illumination angle of 15°. The physical property values and the results obtained are shown in Table 3. The reflection white luminance was more than 600 cd/m² indicating that a bright screen can be provided.

### EXAMPLE 13

A scattering sheet was obtained in the same manner as that described in Example 10, except that the thickness of a layer of the mixture applied to the film was increased. The scattering sheet laminated on a glass plate was obtained in the same manner as that described in Example 10. This scattering sheet was subjected to test (B) for evaluation of the reflection luminance and the reflection contrast (direct illumination) at an illumination angle of 15°. The physical property values and the results obtained are shown in Table 3. The reflection white luminance was more than 600 cd/m² indicating that a bright screen can be provided.

### EXAMPLE 14

A scattering sheet was obtained in the same manner as that described in Example 11, except that 73 parts in terms of the solid content of a material solution of the pressure-sensitive adhesive No. K as the colorless transparent resin and 27 parts of TOSPEARL® #145 as the colorless transparent spherical particles were used. The amount of the colorless transparent spherical particles is about 37 parts with respect to 100 parts of the colorless transparent resin. The scattering sheet laminated on a glass plate was obtained in the same manner as that described in Example 10. This scattering sheet was subjected to test (B) for evaluation of the reflection luminance and the reflection contrast (direct illumination) at an illumination angle of 15°. The physical property values and the results obtained are shown in Table 3. The reflection white luminance was more than 600 cd/m², indicating that a bright screen can be provided.

### EXAMPLE 15

A scattering sheet was obtained in the same manner as that described in Example 10, except that the pressure-sensitive adhesive No. T was used as the colorless transparent resin and that 70 parts in terms of the solid content of a material solution of this adhesive and 30 parts of TOSPEARL®#145 as the colorless transparent spherical particles were used. The amount of the colorless transparent spherical particles is about 43 parts with respect to 100 parts of the colorless transparent resin. The scattering sheet laminated on a glass plate was obtained in the same manner as that described in Example 10. This scattering sheet was subjected to test (B) for evaluation of the reflection luminance and the reflection contrast (direct illumination) at an illumination angle of 15°. The physical property values and the results obtained are shown in Table 3. The reflection white luminance was more than 600 cd/m², indicating that a bright screen can be provided.

### Comparative Example 4

A scattering sheet was obtained in the same manner as that described in Example 12, except that EPOSTARO MS was used as the colorless transparent spherical particles and that 97 parts in terms of the solid content of a material solution of the pressure-sensitive adhesive No. 0 as the colorless transparent resin and 3 parts of EPOSTAR® MS were used. The amount of the colorless transparent spherical particles is about 3 parts with respect to 100 parts of the colorless transparent resin. The scattering sheet laminated on a glass plate was obtained in the same manner as that described in Example 10. This scattering sheet was subjected to test (B) for evaluation of the reflection luminance and the reflection contrast (direct illumination) at an illumination angle of 15°. The physical property values and the results obtained are shown in Table 3. The reflection white luminance was less than 600 cd/m², indicating that a dark screen is obtained.

TABLE 3

| | | Total | | | |
|---|---|---|---|---|---|
| | | light | | Reflection | |
| | Film | trans- | | white | |
| | thickness | mittance | Haze | luminance | |
| | (μm) | (%) | (%) | (cd/m²) | Contrast |
| Example 10 | 25 | 93.5 | 70.8 | 738 | 67 |
| Example 11 | 25 | 93.3 | 70.1 | 738 | 68 |
| Example 12 | 25 | 93.4 | 71.2 | 744 | 69 |
| Example 13 | 35 | 94.0 | 76.5 | 781 | 72 |
| Example 14 | 25 | 93.4 | 77.9 | 851 | 68 |
| Example 15 | 25 | 94.2 | 83.3 | 777 | 64 |
| Comparative | 25 | 91.1 | 68.3 | 434 | 24 |
| example 4 | | | | | |

Thus, the scattering sheet of the present invention or the laminated sheet of the present invention obtained by combining the scattering sheet with another sheet or film can provide a bright screen when it is used for a front scattering sheet in a reflective or transflective liquid crystal display device.

What is claimed is:

1. A scattering sheet obtained by forming a scattering resin into a sheet having a thickness of about 1 μm to about 100 μm, and having a total light transmittance T satisfying expression (I):
about 85%≦T< about 100% (I)
and a haze Hz satisfying expression(II):
about 50%≦Hz< about 90% (II),
wherein the scattering resin comprising a colorless transparent resin and colorless transparent spherical particles dispersed in the colorless transparent resin, a refractive index n(R) of the colorless transparent resin and a refractive index n(F) of the colorless transparent spherical particles satisfy expression(III):
about 0.00<n(R) n(F)≦ about 0.05 (III),
an average particle size φ of the colorless transparent spherical particles satisfies expression(IV):
about 2 μm≦φ≦ about 5 μm (IV),
and a content of the colorless transparent spherical particles is about 1 to about 100 parts by weight with respect to 100 parts by weight of the colorless transparent resin.

2. A scattering sheet according to claim 1, wherein the content of the colorless transparent spherical particles is about 1 to about 50 parts by weight with respect to 100 parts by weight of the colorless transparent resin.

3. A scattering sheet according to claim 1, wherein the refractive index n(R) of the colorless transparent resin satisfies expression (V):
about 1.40<n(R)≦ about 1.50 (V).

4. A scattering sheet according to claim 1, wherein the colorless transparent resin is an acrylic pressure-sensitive adhesive.

5. A scattering sheet according to claim 1, wherein the colorless transparent spherical particles are made of a silicone resin.

6. A scattering sheet according to claim 1, wherein a phase retardation value of the scattering sheet is about 30 nm or less.

7. A laminated sheet comprising the scattering sheet according to according to any of claims 1 to 6 and two resin sheets, wherein the scattering sheet is sandwiched by two resin sheets.

8. A laminated sheet comprising the scattering sheet according to any of claims 1 to 6 and a stretched resin sheet, wherein the stretched resin sheet is laminated on the scattering sheet.

9. A laminated sheet according to claim 8, wherein the stretched resin sheet is a polarizing film or a phase retardation film.

10. A laminated sheet according to claim 9, wherein the stretched resin sheet is a phase retardation film selected from a quarter-wave film and a half-wave film.

11. A laminated sheet according to claim 8, wherein the stretched resin sheet is composed of a polarizing film and at least one phase retardation film, and the polarizing film and the phase retardation film are laminated on the scattering sheet in layers.

12. A laminated sheet comprising the scattering sheet according to any of claims 1 to 6 and a reflective film or a transflective film, wherein the reflective film or the transflective film is laminated on the scattering sheet in layers.

13. A laminated sheet according to claim 12, wherein further a polarizing film is laminated thereon.

14. A liquid crystal display device comprising the laminated sheet according to claim 11 laminated on the front of a liquid crystal cell.

15. A liquid crystal display device according to claim 14, wherein a polarizing film is laminated on the back of the liquid crystal cell, and a backlighting device is placed on the back of the polarizing film.

16. A liquid crystal display device according to claim 15, wherein a phase retardation film is laminated together with the polarizing film on the back of the liquid crystal cell.

17. A liquid crystal display device comprising a polarizing film laminated on the front of a liquid crystal cell, and the laminated sheet according to claim 13 laminated on the back of the liquid crystal cell.

18. A liquid crystal display device according to claim 17, wherein a phase retardation film is laminated together with the polarizing film on the front of the liquid crystal cell.

19. A liquid crystal display device according to claim 17 or 18, wherein a backlighting device is placed on the back of the laminated sheet laminated on the back of the liquid crystal cell.

20. A liquid crystal display device according to claim 17 or 18, wherein a phase retardation film is laminated together with the laminated sheet on the back of the liquid crystal cell.

21. A liquid crystal display device according to claim 20, wherein a backlighting device is placed on the back of the laminated sheet laminated on the back of the liquid crystal cell.
